(19) United States
(12) Patent Application Publication
(10) Pub. No.: US 2014/0108926 A1
(43) Pub. Date: Apr. 17, 2014

(54) USING METADATA

(71) Applicants: Jarmo Antero Nikula, Jaali (FI); Mika Allan Salmela, Oulu (FI); Jyrki Veikko Leskela, Haukipudas (FI); Aki Happonen, Kiiminki (FI)

(72) Inventors: Jarmo Antero Nikula, Jaali (FI); Mika Allan Salmela, Oulu (FI); Jyrki Veikko Leskela, Haukipudas (FI); Aki Happonen, Kiiminki (FI)

(73) Assignee: NOKIA CORPORATION, Espoo (FI)

(21) Appl. No.: 14/006,499

(22) PCT Filed: Mar. 30, 2011
(86) PCT No.: PCT/IB11/51369

§ 371 Date: Oct. 17, 2013

(51) Int. Cl. G06F 17/21

(52) U.S. Cl. CPC G06F 17/21
USPC 715/273

(57) ABSTRACT

A method comprises retrieving metadata from at least one memory, the metadata comprising statistical information associated with each of a plurality of sub-items of a static content item, and causing a representation of the static content item to be displayed on a display, the representation comprising plural sections, each of the sections representing a different sub-item, the appearance of each of the sections having been adapted based on the metadata associated with the corresponding sub-item so as to communicate statistical information associated with the sub-item to a user.

### FIELD OF THE INVENTION

This specification relates to using metadata. In particular, this specification relates to using metadata associated with a static content item.

### BACKGROUND TO THE INVENTION

A large number of electronic devices include functionality for enabling users to view readable-content items, such as electronic books, magazines and newspapers. Such devices include mobile telephones, tablet computers and e-readers.

### SUMMARY OF THE INVENTION

According to a first aspect, this specification describes a method comprising retrieving metadata from at least one memory, the metadata comprising statistical information associated with each of a plurality of sub-items of a static content item, and causing a representation of the static content item to be displayed on a display, the representation comprising plural sections, each of the sections representing a different sub-item, the appearance of each of the sections having been adapted based on the metadata associated with the corresponding sub-item so as to communicate statistical information associated with the sub-item to a user.

According to a second aspect, this specification describes apparatus comprising at least one processor and at least one memory, the at least one memory having stored thereon computer readable instructions which, when executed by the at least one processor, cause the at least one processor: to retrieve metadata from at least one memory, the metadata comprising statistical information associated with each of a plurality of sub-items of a static content item; and to cause a representation of the static content item to be displayed on a display, the representation comprising plural sections, each of the sections representing a different sub-item, the appearance of each of the sections having been adapted based on the metadata associated with the corresponding sub-item so as to communicate statistical information associated with the sub-item to a user.

According to a third aspect, this specification describes a non-transitory memory medium having stored thereon computer-readable instructions which, when executed by at least one processor, cause the at least one processor: to retrieve metadata from at least one memory, the metadata comprising statistical information associated with each of a plurality of sub-items of a static content item; and to cause a representation of the static content item to be displayed on a display, the representation comprising plural sections, each of the sections representing a different sub-item, the appearance of each of the sections having been adapted based on the metadata associated with the corresponding sub-item so as to communicate statistical information associated with the sub-item to a user.

According to a fourth aspect, this specification describes apparatus configured: to retrieve metadata from at least one memory, the metadata comprising statistical information associated with each of a plurality of sub-items of a static content item; and to cause a representation of the static content item to be displayed on a display, the representation comprising plural sections, each of the sections representing a different sub-item, the appearance of each of the sections having been adapted based on the metadata associated with the corresponding sub-item so as to communicate statistical information associated with the sub-item to a user.

Each of the sections may comprise a link to the sub-item which the section represents, and the apparatus may be configured to be responsive to a user selection of a link to cause at least a part of the sub-item with which the link is associated to be displayed on the display. The apparatus may be configured: subsequent to receiving the user selection of the link, to update the statistical information associated with the sub-item with which the link is associated.

The apparatus may be configured to be responsive to a user input in respect of a one of the sections to display textually and/or numerically information associated with the sub-item which is represented by the one of the sections.

The metadata may comprise plural sets of statistical information, the representation may comprise a first part and a second part, each of the first and second parts comprising plural sections and the apparatus may be configured: to adapt the appearances of the sections of the first part of the representation based on a first of the plural sets of statistical information; and to adapt the appearances of the sections of the second part of the representation based on a second of the plural sets of statistical information.

According to a fifth aspect, this specification describes apparatus comprising: means for retrieving metadata from at least one memory, the metadata comprising statistical information associated with each of a plurality of sub-items of a static content item; and means for causing a representation of the static content item to be displayed on a display, the representation comprising plural sections, each of the sections representing a different sub-item, the appearance of each of the sections having been adapted based on the metadata associated with the corresponding sub-item so as to communicate statistical information associated with the sub-item to a user.

Each of the sections may comprise a link to the sub-item which the section represents, and the apparatus may comprise: means for responding to a user selection of a link by causing at least a part of the sub-item with which the link is associated to be displayed on the display. The apparatus may comprise means for updating the statistical information associated with the sub-item with which the link is associated, subsequent to receiving the user selection of the link.

The apparatus may comprise means for responding to a user input in respect of a one of the sections by displaying textually and/or numerically information associated with the sub-item which is represented by the one of the sections.

The metadata may comprise plural sets of statistical information, the representation may comprise a first part and a second part, each of the first and second parts comprising plural sections, and the apparatus may comprise: means for adapting the appearances of the sections of the first part of the representation based on a first of the plural sets of statistical information; and means for adapting the appearances of the sections of the second part of the representation based on a second of the plural sets of statistical information.

According to a sixth aspect, this specification describes computer-readable instructions which, when executed by at least one processor, cause the at least one processor to perform a method according to the first aspect.

### BRIEF DESCRIPTION OF THE FIGURES

For a more complete understanding of example embodiments of the present invention, reference is now made to the following description taken in connection with the accompanying drawings in which:

FIG. 1 is a schematic illustration of an apparatus according to example embodiments of the invention;

FIG. 2 is an electronic device according to example embodiments of the invention;

FIG. 3 is a flow chart illustrating a method according to example embodiments of the invention;

FIGS. 4A to 4D illustrate a state of a display panel at various points throughout the method of FIG. 3; and

FIGS. 5A and 5B illustrate alternative adaptations of the representation according to example embodiments of the invention.

### DETAILED DESCRIPTION OF THE EMBODIMENTS

In the description and drawings, like reference numerals refer to like elements throughout.

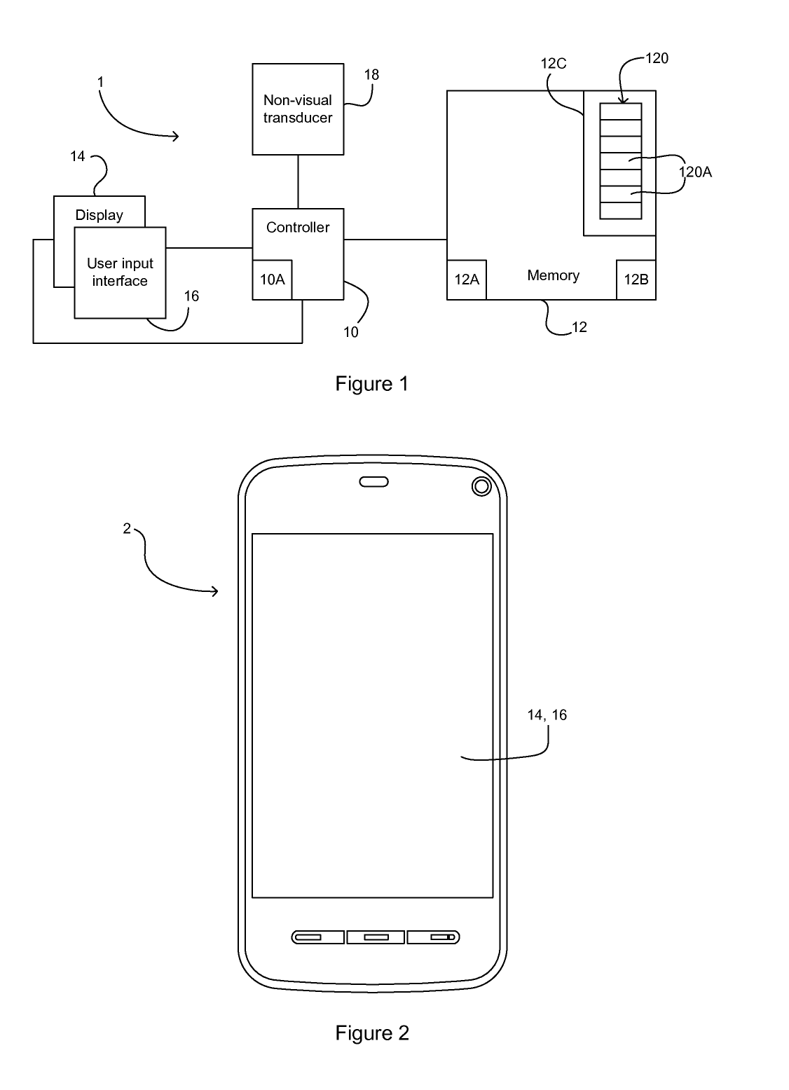

FIG. 1 is a simplified schematic of apparatus 1 according to example embodiments of the invention. The apparatus 1 comprises a controller 10. The controller 10 includes at least one processor 10A, which operates under the control of computer-readable instructions 12A optionally stored on a non-transitory memory medium 12. The controller 10 may also comprise one or more application-specific integrated circuits (ASICs) (not shown). The controller 10 is operable, under the control of the computer-readable instructions 12A to control other components of the apparatus 1. The memory 12 may comprise, for example, ROM, RAM or flash memory.

In the example embodiment of FIG. 1, the apparatus 1 comprises a display 14 and a user input interface 16. The display 14 is operable to receive signals from the controller 10 and, in response, to display images and/or text for consumption by the user of the apparatus 1. The user input interface 16 is operable to receive user inputs from the user and to send signals indicative of such to the controller 10. The controller 10 is responsive to these signals to control other components of the apparatus 1 in a suitable manner. In the example of FIG. 1, the user input interface 16 comprises a touch-sensitive transducer. The touch-sensitive transducer is overlaid on the display panel to form a touchscreen 14, 16. The controller 10 is operable to determine, based on signals received from the touch-sensitive transducer 16, a location at which the touch input is incident on the touchscreen 14, 16.

It will be appreciated that the user input interface 16 may alternatively comprise a touch pad, a scroll wheel, a track ball, one or more mechanical or touch-sensitive keys or any other type of suitable user input interface. Such interfaces may be used in conjunction with a cursor or marker displayed on the display 14 in order for users to provide inputs or make selections of items at various locations on the display 14.

The apparatus 1 of FIG. 1 also comprises a non-visual output transducer 18 for providing non-visual feedback to a user. The non-visual output transducer 18 operates under the control of signals received from controller 10. The non-visual output transducer 18 may comprise, for example, a loudspeaker or a haptic feedback module. In some example embodiments, the apparatus 1 may comprise both a loudspeaker and a haptic feedback module.

The memory 12 comprises a static content item store 12C. The static content item store 12C is operable to store at least one static content item. Static content items 120 are content items in which at least part of the content is static (i.e. stationary) when displayed on the display 14. Static content includes text and still images. Examples of static content items 120 include, but are not limited to, electronic books (including picture and photograph books etc.), electronic magazines, electronic newsletters, electronic brochures and electronic newspapers. A static content item 120 may comprise an electronic version of any tangible (i.e. physical) static-content item. Readable-content items are a type of static content item. Readable content items comprise content which can be read by a user, when displayed on a display 14. The controller 10 is operable, under the control of the computer readable instructions 12A, to retrieve a static content item 120 from the store 12C and to cause it to be displayed on the display 14. The portion of the computer readable instructions 12A which causes the controller 10 to retrieve and display static content items 120 may comprise, for example, an e-reader application.

Also stored in the memory is a metadata database 12B. The metadata database 12B is operable to store metadata associated with at least one static content item 120 stored in the static content item 120 store 12C. The metadata comprises at least one set of statistical information relating to the at least one static content item 120.

The apparatus 1 may also comprise a receiver or a transceiver for receiving data from a network such as, but not limited to, the internet.

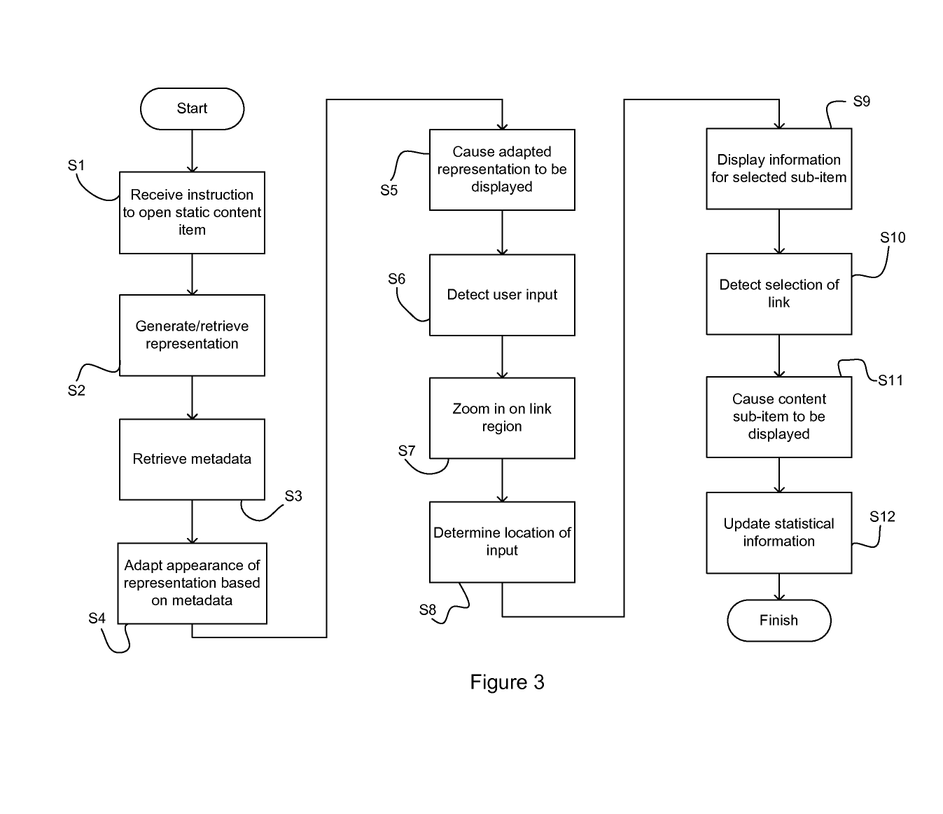

FIG. 2 is an illustration of a device 2 according to example embodiments of the invention. In this example, the device 2 comprises a controller 10 (not visible in FIG. 2), a memory 12 (also not visible in FIG. 2), a display panel 14 and a user input interface 16. These components are the same as the equivalent components described with reference to FIG. 1. The device 2 may comprise other components, such as one or more non-visual output transducer 18. In the example of FIG. 2, the device 2 is a portable device. In particular, the device 2 is a mobile telephone. It will be appreciated, however, that the device 2 may comprise another type of device, such as but not limited to a tablet computer, an e-reader, a PDA, a notebook computer, a laptop or desktop computer.

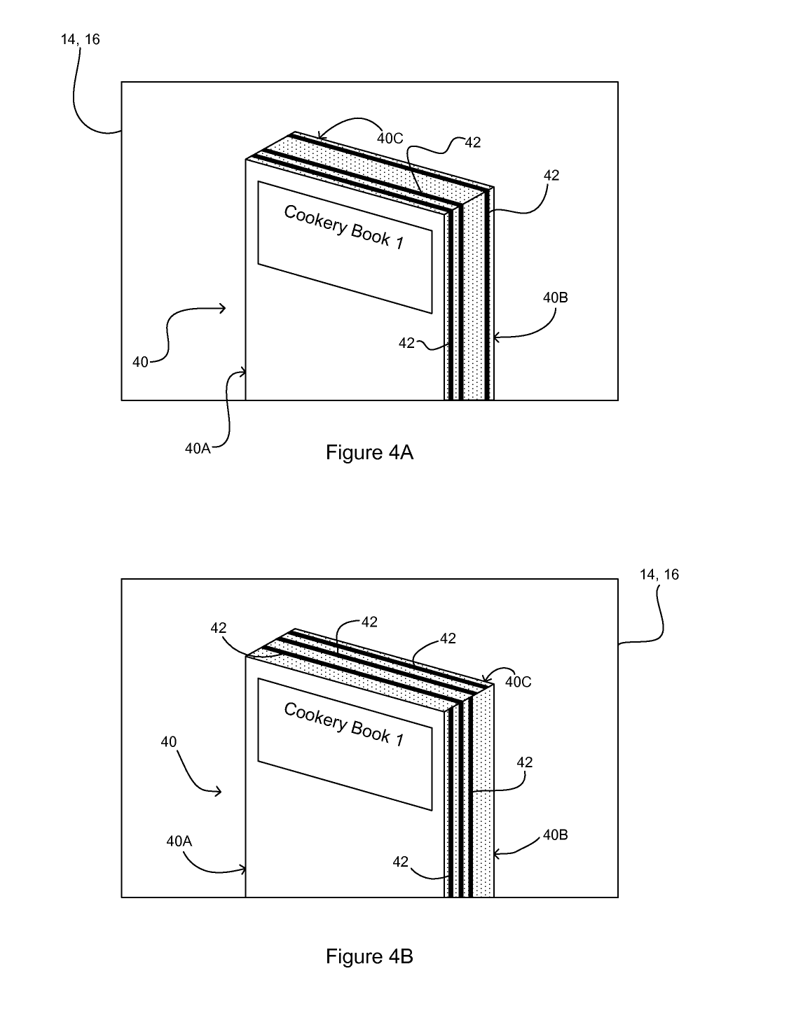

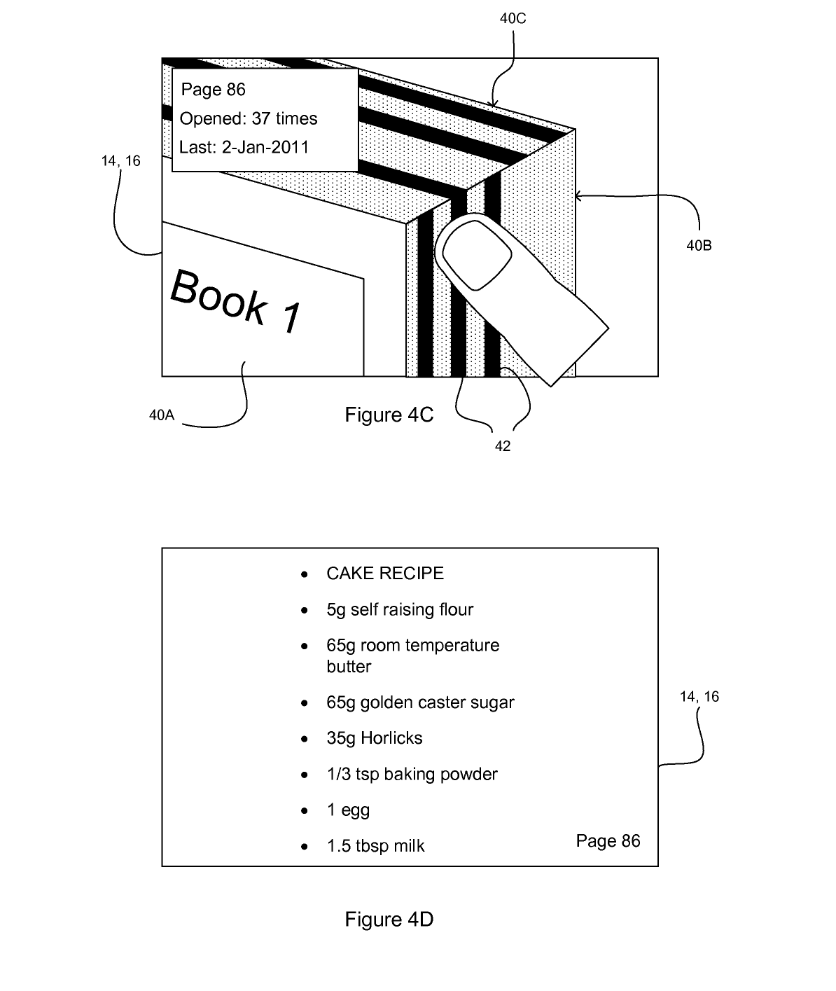

FIG. 3 is a flow chart illustrating a method according to example embodiments of the invention. FIG. 3 will be described in conjunction with FIGS. 4A to 4D which illustrate a state of the display at various points throughout the method of FIG. 3.

In step S1, the controller 10 receives an instruction that a static content item 120 is to be displayed on the display 14. This instruction may result directly or indirectly from an input received from a user.

In step S2, the controller 10 generates a representation 40 of the static content item 120 that is to be displayed. The representation 40 comprises plural links 42 to the static content item 120. The controller 10 is responsive to a user selection of a link 42 to cause at least a part of the static content item 120 to be displayed on the display 14.

A static content item is divided into plural content sub-items 120A. Each content sub-item 120A may comprise a page or a group of pages (for example, a chapter) of the static content item 120. The representation comprises a plurality of links 42 each linking to a different content sub-item 120. In this way, a user is able to navigate to a particular content sub-item 120A by selecting the appropriate link from the representation 40.

The representation 40 comprises a link region 40B, 40C in which the links are provided. The representation 40 may also comprise an identifier portion 40A, which identifies the static content item 120 to the user.

In some example embodiments, the representation 40 comprises a pictorial representation of the static content item. The representation 40 may comprise an image of a physical version of the static content item. For example, if the static content item 120 is a book, the representation 40 may comprise an image of a book.

In example embodiments such as those shown in FIGS. 4A to 4C, the representation 40 comprises a three-dimensional image of at least a portion of a book. As such, the identifier region 40A comprises a front cover 40A and the link region 40B, 40C comprises at least one side face. The at least one side face 40B; 40C is equivalent to a face of a physical book on which the edges of the pages of the book are visible. Each of the links 42 in the link region 40B, 40C has the appearance of a page, or a group of pages, of a book. The links 42 are provided in the link region 40B, 40C in a logical order. As such, the location of a link 42 within the link region is based upon the position of the sub-item 120A within the static content item 120. Consequently, links 42 provided nearer to the front cover 40A of the representation 40 are associated with content sub-items 120A nearer to the beginning of the static content item 120.

In the examples shown in FIGS. 4A to 4C, the link region comprises the side face 40B and the top face 40C of a book. In these examples, each of the links is provided on both the side face 40B and the top face 40C.

The controller 10 may use a generic template to generate the representation 40. The controller 10 may modify the template based on properties of the static content item. The properties may, for example, be stored in the static content item 120 store 12C in association with the static content item. The properties may include, for example, the title and the sub-items. The controller 10 may modify the template such that the front cover includes the title of the static content item, and such that the size of the link region (which, in this example, is equivalent to the thickness of the book) is representative of the number of sub-items 120A of the static content item. The controller 10 divides the link region into a number of sections (or sub-portions) each representing and corresponding to a sub-item 120A of the static content item. In embodiments in which the number of sub-items 120A is so large that each section of the link region cannot be resolved by the user, the controller 10 may use a suitable algorithm so as to cause the link region to appear to comprise a plurality of pages.

The above description of the generation of the representation 40 is merely one example. It will, thus, be appreciated that generation of the representation 40 may be carried out in any other suitable way.

In alternative embodiments, step S2 may comprise the controller 10 retrieving the representation 40 from the memory 12. The representation 40 may be stored in association with its associated static content item 120.

Following the retrieval or generation of the representation 40, the controller 10 may provide the links 42 within the link region 40B, 40C. In embodiments in which the representation 40 is retrieved from memory, the representation 40 may already be provided with links 42. The controller 10 may allocate links 42 dependent on the number of sub-items. For example, if the number of sub-items 120A is too large for a link to each sub-item 120A to be easily resolved by the user, the controller 10 may instead provide a link to a group of sub items. In alternative embodiments, the controller 10 may provide link to every n^{th} sub-item.

According to other alternative embodiments, the links may be provided based on the statistical information retrieved in step S3. This is discussed below in more detail.

In the above described embodiments, the representation 40 is a three-dimensional image of a physical version of the static content item. It will be appreciated however that this may not be the case. For example, the representation 40 may comprise a two-dimensional image, which includes an identifier region 40A and a link region 40B, 40C.

In step S3, the controller 10 retrieves, from the metadata database 12B, metadata associated with the static content item 120 that is to be displayed. The metadata comprises at least one set of statistical information relating to the static content item.

The statistical information may comprise, for example, one or more of the following metrics: the number of times each sub-item 120A has been previously viewed by the user, the total time the user has spent viewing each sub-item, the time spent viewing each sub-item 120A the last time the item was viewed, the date on which each sub-item 120A was last viewed, and the time that has elapsed since each sub-item 120A was last viewed by the user. This information may be dynamically updated by the controller 10 as and when each of the sub-items 120A is viewed. Statistical information which is updated by the controller 10 may be referred to as dynamic information.

The statistical information may also comprise information that is received, in real-time, over a communication link and that is stored temporarily in the metadata store 12C. For example, the statistical information may comprise a number of users of other devices who are currently viewing a particular sub-item. Identifiers of the users (e.g. names, avatars, icons, photographs etc.) who are currently viewing a particular sub-item 120A may be stored in association with the statistical information associated with that sub-item. Also, the statistical information may comprise a number of users who have posted comments in relation to the particular sub-item. The comments and/or identifiers of the users who posted the comments related to a particular sub-item 120A may be stored in association with the statistical information relating to that sub item.

The statistical information may, also or alternatively, include statistical information which is not dynamic (i.e. which is not updated by the controller 10). Such statistical information may have been provided when the content item 120 was downloaded to the content item 120 store 12C. For example, the statistical information may comprise one or more of: the number of times each sub-item 120A is referenced within the static content item 120, the popularity of each sub-item 120A (e.g. number of views or time spent viewing) based on statistics gathered from other users of the static content item 120, and the number of prior users who have written comments about a particular sub-item. The comments and/or identifiers of the users who posted the comments related to a particular sub-item 120A may be stored in association with the statistical information relating to that sub item.

The metadata may, alternatively or additionally, include statistical information generated by the controller 10 in response to a user request, such as a key-word search. As such, the statistical information may specify the number of times a key-word appears in each sub-item.

At a very basic level, statistical information may include information identifying whether or not a sub-item 120A has a particular characteristic. For example, the statistical information may comprise either a “1” (a one) or a “0” (a zero) in relation to each sub-item. Thus, if the statistical information relates to whether or not a sub-item 120A has a comment associated with it, a “1” may indicate that the sub-item 120A does have a comment associated with it and a “0” may indicate that the sub-item 120A does not have a comment associated with it. Alternatively, or in addition, the statistical information may include a metric associated with each sub-item, the metric being indicative of a particular measurement (such as number of views, or time spent viewing) associated with the sub-item.

In step S4, the controller 10 adapts the appearance of the representation 40 based on the retrieved metadata. In this way, when in step S5 the adapted representation is displayed on the display 14, the statistical information is communicated the user.

The controller 10 adapts the appearance of the links 42 based on the metric contained in the statistical information which relates to a sub-item 120A with which the link is associated. As such, the appearance of a link to a sub-item 120A is adapted so as to communicate statistical information about that sub-item 120A to the user.

The appearance may be adapted by, for example, using different colours for different magnitudes of a particular metric contained within the statistical information. For example, links 42 which are associated with sub-items 120A for which the metric is above a first threshold may be provided in a first colour. The links which are associated with sub-items 120A for which the metric is below the first threshold may be uncoloured or provided in a second colour. In this way, the user is easily able to discern information about a particular sub-item. If, for example, the metric describes the number of times a sub-item 120A has been viewed, the user would easily be able to discern which of the sub-items 120A has been viewed most often and would be able to cause that sub-item 120A to be displayed by selecting the link 42. This may be useful, for example, when the readable content item 120 is a cookery book. By altering the appearance of a link dependent on the number of times that sub-item 120A has been opened, the user is easily able to identify and navigate to their favourite recipe without needing to negotiate any complex menu system.

There may be plural different thresholds, each having an associated colour. As such, different links 42 may be coloured differently depending on the magnitude of the metric associated with their respective sub-items. In some embodiments, a first link having the highest metric may be adapted in a first colour and second link having a lowest metric may be adapted in a second colour. The remainder of the links may be adapted so as to be of hues falling between the first and second colours, depending on the magnitude of their associated metric. As such, the hue of a link having a metric near the highest value in the range may comprise a larger amount of the first colour, and a link having a metric near the lower end of the range may be of a hue which includes a larger proportion of the second colour. For example, the first colour may be red and the second colour may be yellow and the links having a metric which falls between the two ends of the range may be coloured in different hues of orange.

The threshold or thresholds may be automatically determined depending on the range of the statistical information. For example, the controller 10 may be operable to adapt those links 42 for which the associated sub-item 120A has a metric falling within a particular band of percentiles. As such, the links 42 which are associated with sub-items 120A having a metric falling within the highest five percent may be distinguished from the other links.

As mentioned above, the links 42 may allocated to a sub-item 120A and provided within the link region 40B, 40C based on the statistical information. For example, links 42 may be provided only to those sub-items 120A for which the metric satisfies a particular criterion (e.g. which have been displayed more than ten times). In such embodiments, the links 42 may be separated within the link region by portions which do not link to sub-items. The links may be provided at location in the link region which represents the location of their sub-item 120A within the content item. As such, a link to the thirtieth of one hundred sub-items 120A may be provided approximately one third of the way through the link region 40A, 40B. In some embodiments, the links 42 may be adapted so as to communicate the magnitude of a metric relating to a particular sub-item 120A to the user. For example, a link may be adapted to include a plurality of distinct markings. In such embodiments, the number of markings may be representative of the magnitude of the metric. In some examples, the number of markings may be equal to the magnitude of the metric. In other embodiments, the magnitude may be a multiple of the number of markings displayed. In some examples, the links 42 may be adapted so as to communicate the magnitude of the metric, and also so as to communicate a location within the sub-item 120A to which the link relates. For example, the position of a marking may be representative of a location within a sub-item 120A of content of interest to the user. For example, where the statistical information comprises a key-word search, the link 42 may be adapted so as to include a marking for each occasion of the key-word within the sub-item, the markings being provided at a location on the link 42 that is representative of a location of an instance of the key-word within the sub-item. As such, if a key-word is near the bottom of a page of a book, for example, the marking may be provided towards the bottom of the link 42.

In step S5, the adapted representation is caused to be displayed on the display 14.

FIG. 4A depicts an example of an adapted representation 40 of a static content item 120 displayed on the display 14. In this example, the links 42 to sub-items 120A for which the metric contained in the statistical information satisfies a particular criterion are shaded. The remainder of the links, which are associated with sub-items 120A having metrics which do not satisfy the criterion, are un-shaded.

In example embodiments in which plural different colours are used for plural different levels of a particular metric, there may sometimes be distinct edges between the links of different colours (for example, when one sub-item 120A has been viewed many times, but the next sub-item 120A has never been viewed). In some embodiments, these distinct edges may be smoothed by using a sliding average of metric values from plural consecutive sub-items.

In other example embodiments, the representation 40 may be adapted based on more than one different set of statistical information. In such embodiments, a first part of a link may adapted based on a metric from a first set of statistical information and a second part of a link may be adapted based on a metric from a second set of statistical information. In alternative embodiments, the link region 40B, 40C may be split into two portions. In such embodiments, in the first portion, the controller 10 may provide links only to those sub-items 120A for which a metric from a first set of statistical information satisfies a particular criterion. In the second portion, the controller 10 may provide links only for those sub-items 120A for which a metric from a second set of statistical information satisfies a particular criterion. It will be appreciated that, depending on the statistical information of each set, the first and second portions may comprise links to the same sub-item.

In FIG. 4B, the side face 40B of the representation 40 is adapted based on a first set of statistical information and the top face 40C is adapted based on a second set of statistical information. This may be useful, for example, when a user has performed two key-word searches. The side face 40B may be adapted to distinguish those sub-items 120A in which the subject of the first key-word search appears more than a certain number of times. The top face 40C may be adapted to distinguish those sub-items 120A in which the subject of the second key-word search appears more than a certain number of times. In this way, the user is able easily to cross-reference the results of the two searches to determine which sub-items 120A include repeated instances of both of the key-words.

It will be appreciated that, according to some example embodiments one or more of the faces 40B, 40C may be adapted based on plural sets of statistical information. For example, the side face 40B may be divided into four regions with a first region being adapted based on a first set of statistical information, a second region being adapted based on a second set of statistical information and so on.

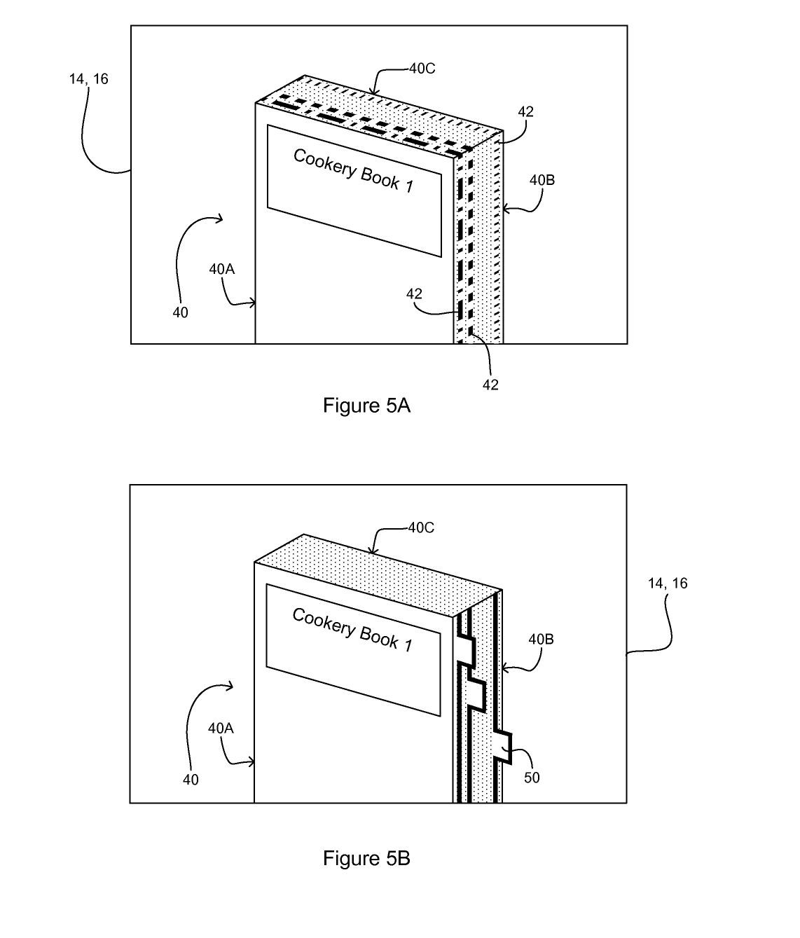

In the above examples, the representation 40 is adapted by applying different colours to different links. It will be appreciated, however, that the representation 40 may be adapted in another way, for example, by applying different shades or patterns to different links of the representation 40. An example of different patterns applied to the representation 40 can be seen in FIG. 5A.

Other examples of adaptation of the representation 40 include adapting the shape of the links based on the statistical information. For example, links which relate to sub-items 120A having a metric which is above a certain threshold may be adapted so as to appear to include tabs 50. Such an example is illustrated in FIG. 5B. In some examples, the tabs may include statistical or other information in the form of numbers, letters or icons. In some examples, the way in which the link is shaped may be based on the size of the metric associated with that link. For example, if we consider the “tab” example shown in FIG. 5B, the size of the tabs 50 may be based on the size of the associated metric. As such, the controller 10 may adapt a link associated with a metric having a large magnitude so as to include in a tab of a larger size. Similarly, links associated with metrics of a smaller magnitude may be adapted to include tabs of a smaller size. In other examples, the representation may be adapted such that links associated with, for example, a metric above a particular threshold, have the appearance of open or partially pages of a book.

In some embodiments, the controller 10 may be responsive to user inputs to change the angle at which the representation 40 is viewed. For example, the controller 40 may cause the representation to be rotated such that a different edge (e.g. the bottom edge) becomes visible on the display 14. The bottom edge may also be adapted based on a set of statistical information, so as to communicate that information to the user. The bottom edge may also comprise one or more links to sub-items. The representation may alternatively be adapted to show three or four edges of the book at the same time. Such a view is not realistic but allows more information to be provided to the user.

In some example embodiments, the adaptation applied to the link region may be partially transparent. In this way, the underlying representation remains entirely visible, even after adaptation.

Referring back to FIG. 3, in step S6, the controller 10 detects a user input. The user input is detected based on signals received from the user input interface 16.

In step S7, in response to detecting the user input, the controller 10 causes the adapted representation 40 to be magnified (or zoomed). In particular, the controller 10 causes the representation 40 to be zoomed in on the link region 40B, 40C. This allows better resolution of the links. FIG. 4C shows the representation 40 zoomed in on the edge between the top and side faces 40C, 40B of the representation 40.

Next, in step S8, the controller 10 determines a location of a user input. The controller 10 determines the location of the user input based on signals received from the user input interface 16. In the example embodiments in which the user input interface 16 comprises a touch-sensitive transducer, the user input comprises a touch input being incident on the touchscreen 14, 16. In other example embodiments, in which the user input interface 16 is not a touch-sensitive transducer, the location may be determined based on the location at which a cursor or marker is displayed on the display 14.

In step S9, the controller 10 identifies the link which is displayed at the location of the user input. The controller 10 then causes a metric (or metrics) relating to the sub-item 120A with which the identified link is associated to be displayed in textual and/or numerical form. The controller 10 may also cause the identity of the sub-item 120A to be displayed. This allows the user to select a particular link with the knowledge of the sub-item 120A with which the link 42 is associated. Thus, the occurrence of erroneous link selections is reduced. FIG. 4C depicts an example in which the displayed metrics include the number of times that a page has been opened and the date on which the page was previously opened.

It will be appreciated that the statistical information which is displayed in textual and/or numerical form may comprise the statistical information based on which the representation was adapted and/or other information (such as, but not limited to, a different set of statistical information). For example, in addition, or alternatively, to showing a number of comments that have been written in relation to a particular sub-item, identifiers relating to the authors of the comments and/or the comments themselves may be caused to be displayed. Additionally or alternatively, a network link to a network resource at which the comments can be viewed may be caused to be displayed. In response to receiving a selection of the network link to the network resource, the controller 10 may be operable to use, for example, a browser application to navigate to the network resource, thereby to allow the user of the device to view the comments.

The controller 10 is operable to respond to the user moving the location of the user input by changing the statistical information displayed on the display in dependence on the location of the user input. According to some example embodiments, as the user moves the user input from one link to the next, the controller 10 may cause non-visual feedback to be provided to user via the non-visual output transducer 18. This may comprise, for example, a loudspeaker outputting a sound, such as that of a person flicking through the pages of a book. Additionally or alternatively, this may comprise a haptic feedback module providing haptic feedback to simulate the sensation of a user flicking through the pages of a book. In example embodiments in which the apparatus comprises a touchscreen 14, 16, the vibration module may comprise, for example, a piezo-electric actuator for causing the touchscreen 14, 16 to vibrate.

In some embodiments, the feedback provided by the non-visual output transducer may be modulated based on the magnitude of the metric that is associated with the link upon which the user input is incident. For example, a noise emitted by a loudspeaker may be louder or of a higher frequency when the user input is incident on a link 42 for which the associated metric is above a certain level. Similarly, the level of haptic feedback may be modulated, such that the user is able to tell, by touch, when their finger is located at a link, the sub-item 120A of which has an associated metric which satisfies a particular criterion. If, for example, the metric is the number of times a sub-item 120A has been viewed, this may simulate a physical book for which it is often possible to determine which pages have been opened most regularly simply by running a finger along the edges of the pages.

In some example embodiments, the representation 40 may be animated as the user input is moved along the links 42. For example, the representation 40 may be animated so as simulate the effect of a reader flicking through the pages of a book.

Next, in step S10, the controller 10 detects a selection of one of the links 42. In example embodiments comprising a touchscreen 14, 16, a selection of a link may be provided by maintaining the touch input at the location of the link for longer than a predetermined duration. Alternatively, in embodiments in which the force of a touch input can be detected, the selection of a link may be provided by pressing on the touchscreen 14, 16 at the location of the link with a force which exceeds a predetermined threshold. In other example embodiments, the selection may be provided by a user applying a “double tap” to the touchscreen 14, 16. In embodiments in which a touchscreen is not provided, a selection may be provided by, for example, pressing a mechanical key when a cursor is displayed at the location of the link. It will be appreciated that the manner in which the link is selected may not be important and may be performed in any suitable way.

Next, in step S11, the controller 10 responds to the selection of a link by causing at least a portion of the sub-item 120A associated with the selected link to be displayed on the display 14. This can be seen in FIG. 4D.

Finally, in step S12, the controller 10 updates the statistical information. For example, in embodiments in which statistical information describes the number of times a sub-item 120A has been viewed, updating the statistical information comprises incrementing by one the metric associated with the selected sub-item.

Example embodiments of the present invention, allow a user easily to locate sub-items 120A of interest and to navigate directly to them without the need to negotiate menu systems and the like. Also, example embodiments of the invention simulate real, physical static content items 120 (such as books) in which information (such as relative popularity of a particular page) can be gleaned simply by looking at and/or touching the edges of the pages of the book.

It will be appreciated that different example embodiments of the invention may not comprise all of the steps described in relation to FIG. 3. For example, some example embodiments may not comprise steps S6 and S7 and/or steps S8 and S9. Similarly, in some embodiments, step S12 may be omitted. It will also be appreciated that the steps of the method are not restricted to the order described with reference to FIG. 3. For example, in some embodiments, the order of steps S2 and S3 may be reversed. In such embodiments, steps S2 and S4 may be performed simultaneously.

According to some example embodiments, the display 14 may be flexible. In such embodiments, a user input may be provided to a location by bending the display at that location. As such, the animation and zooming as described above may be caused in response to detecting the bending of the display at a particular location.

Although the above embodiments have been described primarily with reference to a device, it will be appreciated that the method described with reference to FIG. 3 may be carried out for example by a server located in a network. Display of the representation and provision of user inputs may occur at a user apparatus such as computing apparatus which is in communication with the server over the network.

In the above embodiments, the static content item has been described as a single self-contained content item (e.g. a book, a newspaper etc) with the sub-items comprising, for example, pages or chapters of the single self-contained content item. It will be appreciated however that the static content item may alternatively comprise a library with the sub items comprising the single self-contained static content items (such as books, newspapers etc) of which the library is comprised. In such embodiments, the representation may comprise, for example an image of books stacked in a bookshelf, with the appearance of each of the books being adapted based on associated statistical information.

It should be realized that the foregoing embodiments should not be construed as limiting. Other variations and modifications will be apparent to persons skilled in the art upon reading the present application. Moreover, the disclosure of the present application should be understood to include any novel features or any novel combination of features either explicitly or implicitly disclosed herein or any generalization thereof and during the prosecution of the present application or of any application derived therefrom, new claims may be formulated to cover any such features and/or combination of such features.

1. A method comprising:
retrieving metadata from at least one memory, the metadata comprising statistical information associated with each of a plurality of sub-items of a static content item; and
causing a representation of the static content item to be displayed on a display, the representation comprising plural sections, each of the sections representing a different sub-item, the appearance of each of the sections having been adapted based on the metadata associated with the corresponding sub-item so as to communicate statistical information associated with the sub-item to a user.

2. The method of claim 1, wherein each of the sections comprises a link to the sub-item which the section represents, the method comprising:
responding to a user selection of a link by causing at least a part of the sub-item with which the link is associated to be displayed on the display.

3. The method of claim 2, comprising:
subsequent to receiving the user selection of the link, updating the statistical information associated with the sub-item with which the link is associated.

4. The method of claim 1, comprising:
responding to a user input in respect of a one of the sections by displaying textually and/or numerically information associated with the sub-item which is represented by the one of the sections.

5. The method of claim 1, wherein the metadata comprises plural sets of statistical information, wherein the representation comprises a first part and a second part, each of the first and second parts comprising plural sections, and wherein the appearances of the sections of the first part of the representation are adapted based on a first of the plural sets of statistical information and the appearances of the sections of the second part of the representation are adapted based on a second of the plural sets of statistical information.

6. The method of claim 1, wherein the representation comprises a pictorial representation of the static content item.

7. Apparatus comprising at least one processor and at least one memory, the at least one memory having stored thereon computer readable instructions which, when executed by the at least one processor, cause the at least one processor:
to retrieve metadata from at least one memory, the metadata comprising statistical information associated with each of a plurality of sub-items of a static content item; and
to cause a representation of the static content item to be displayed on a display, the representation comprising plural sections, each of the sections representing a different sub-item, the appearance of each of the sections having been adapted based on the metadata associated with the corresponding sub-item so as to communicate statistical information associated with the sub-item to a user.

8. The apparatus of claim 7, wherein each of the sections comprises a link to the sub-item which the section represents, and wherein the computer-readable instructions, when executed by the at least one processor, cause the at least one processor:
to be responsive to a user selection of a link to cause at least a part of the sub-item with which the link is associated to be displayed on the display.

9. The apparatus of claim 8, wherein the computer-readable instructions, when executed by the at least one processor, cause the at least one processor:
subsequent to receiving the user selection of the link, to update the statistical information associated with the sub-item with which the link is associated.

10. The apparatus of claim 7, wherein the computer-readable instructions, when executed by the at least one processor, cause the at least one processor:
to be responsive to a user input in respect of a one of the sections to display textually and/or numerically information associated with the sub-item which is represented by the one of the sections.

11. The apparatus of claim 7, wherein the metadata comprises plural sets of statistical information, wherein the representation comprises a first part and a second part, each of the first and second parts comprising plural sections, and wherein the computer-readable instructions, when executed by the at least one processor, cause the at least one processor:
to adapt the appearances of the sections of the first part of the representation based on a first of the plural sets of statistical information; and
to adapt the appearances of the sections of the second part of the representation based on a second of the plural sets of statistical information.

12. The apparatus of claim 7, wherein the representation comprises a pictorial representation of the static content item.

13. A non-transitory memory medium having stored thereon computer-readable instructions which, when executed by at least one processor, cause the at least one processor:
to retrieve metadata from at least one memory, the metadata comprising statistical information associated with each of a plurality of sub-items of a static content item; and
to cause a representation of the static content item to be displayed on a display, the representation comprising plural sections, each of the sections representing a different sub-item, the appearance of each of the sections having been adapted based on the metadata associated with the corresponding sub-item so as to communicate statistical information associated with the sub-item to a user.

14. The non-transitory memory medium of claim 13, wherein each of the sections comprises a link to the sub-item which the section represents, and wherein the computer-readable instructions, when executed by the at least one processor, cause the at least one processor:
to be responsive to a user selection of a link to cause at least a part of the sub-item with which the link is associated to be displayed on the display.

15. The non-transitory memory medium of claim 14 having stored thereon computer-readable instructions which, when executed by at least one processor, cause the at least one processor:
subsequent to receiving the user selection of the link, to update the statistical information associated with the sub-item with which the link is associated.

16. The non-transitory memory medium of claim 13 having stored thereon computer-readable instructions which, when executed by the at least one processor, cause the at least one processor:
to be responsive to a user input in respect of a one of the sections to display textually and/or numerically information associated with the sub-item which is represented by the one of the sections.

17. The non-transitory memory medium of claim 13, wherein the metadata comprises plural sets of statistical information, wherein the representation comprises a first part and a second part, each of the first and second parts comprising plural sections, and wherein the computer-readable instructions, when executed by the at least one processor, cause the at least one processor:
to adapt the appearances of the sections of the first part of the representation based on a first of the plural sets of statistical information; and
to adapt the appearances of the sections of the second part of the representation based on a second of the plural sets of statistical information.

18. The non-transitory memory medium of claim 13, wherein the representation comprises a pictorial representation of the static content item.
